(19) United States
(12) Patent Application Publication
(10) Pub. No.: US 2004/0156493 A1
(43) Pub. Date: Aug. 12, 2004

(54) Method and apparatus for providing a central telephony service for a calling party at the called party telephone

(75) Inventor: Avishai Cohen, Nechalim (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 10/739,196

(22) Filed: Dec. 19, 2003

Related U.S. Application Data
(60) Provisional application No. 60/445,245, filed on Feb. 6, 2003.

(51) Int. Cl. H04M 3/42

(52) U.S. Cl. 379/207.04

(57) ABSTRACT

For providing a telephone service between a source telephone and a target telephone, the target telephone is equipped with an incoming channel and an outgoing channel. Upon an incoming call from the source telephone received at the target telephone via the incoming channel being unanswered, the target telephone simultaneously establishes an outgoing call with a server via the outgoing channel. This creates a bridge between the source telephone and the server, thereby rendering a message prompt produced by the telephone service audible at both the source and target telephones. The server may be a voice mail system that allows call screening by the target telephone of a call by the source telephone if the target telephone does not go off-hook within a predetermined time interval. Or the server may provide a personalized ring signal or message to the target telephone until the target telephone goes off-hook.

### RELATED APPLICATION

This application claims the benefit of U.S. Provisional Patent Application No. 60/445,245, titled “Virtual Telephony Answering Machine (VTAM)” filed on Feb. 6, 2003, the disclosure of which is incorporated by reference in its entirety

### FIELD OF THE INVENTION

This invention relates to the provision of telephone services to a calling party. In one embodiment, the invention relates particularly to call screening allowing a called party to filter incoming calls by hearing a caller's voice as the caller leaves a message and deciding whether to break into a normal conversation with the caller or let the caller finish recording the message.

### BACKGROUND OF THE INVENTION

The present absence of call screening in network-based voicemail systems constitutes one of the biggest hindrances to the penetration of such systems into U.S. and other markets. Call screening and visual Message Waiting Indicator (MWI via blinking light) are two of the biggest Telephone Answering Machine (TAM) parity features that are generally unavailable through network-based voicemail. Customer premises devices have traditionally provided these features. A common solution in U.S. markets is to use a Telephone Answering Machine on location (i.e., at home, in the office, etc.), to provide such capabilities. Although network-based voicemail provides many advantages over location-based TAMs, network-based voicemail does not easily provide these two vital capabilities. This causes many subscribers in these markets to prefer home-located TAMs to network-based voicemail, despite other limitations of these TAMs. This technological gap causes network operators to lose potential voicemail air time, and it leaves subscribers with limited functionality.

U.S. Pat. No. 6,310,939, incorporated herein by reference, issued Oct. 30, 2001 in the name of Lucent Technologies, Inc. and entitled “Method and apparatus for screening a call as the call is transmitted to voice mail” discloses a screening and monitoring capability for switch based voice messaging systems that allows a called party to hear the caller and the caller's voice as the caller leaves a message and to break into start a normal telephone conversation if the caller or the caller's subject warrants such action. A switch-based network service feature is provided that controls the bridging of the connections to the voice mail and the called party's telephone station. The service feature turns the voice mail off and destroys the connection if the monitoring called party speaks.

The approach disclosed in U.S. Pat. No. 6,310,939 is incorporated herein by reference and is described only in relation to PSTN networks. PSTN network switch-based solutions have the following disadvantages:

Complexity: They require Advanced Intelligent Network Capabilities from the switch. These are not necessarily supported by all switches.

Each switch might have its own implementation, so a user might have different user experiences using different switches.

They require duplicated resources in the switch.

U.S. Pat. No. 6,353,660 (Burger et al.) issued Mar. 5, 2002, assigned to SS8 Networks, Inc. and entitled “Voice call processing methods” discloses a call screening method that allows a subscriber to screen calls made to the subscriber from callers using the PSTN while the subscriber uses another communications medium, such as VolP. An enhanced services platform (ESP) receives a first call from a caller using a particular public telephone number for the particular subscriber. The ESP identifies the particular public telephone number for the particular subscriber. The ESP accesses a database storing a public telephone number and a private packet-based address for subscribers to retrieve a private packet-based address of the particular subscriber on the basis of the particular public telephone number. An introductory message is provided to the caller and prompts the caller to leave a message. The ESP accesses the particular subscriber based on the particular subscriber private packet-based address to establish an audio connection via the communication medium. The subscriber is notified of the first call. If the subscriber answers the call, a communication path is provided between the caller and the subscriber via the communication medium so that the subscriber may hear the caller leave the message but the caller does not hear or know that the particular subscriber is listening. The ESP connects the caller and the subscriber for two-way communication upon the authorization of the subscriber. In another embodiment, both the caller and the subscriber use a packet-based network. In another aspect of the invention, the ESP records the caller's voice in response to the prompt, and plays the recording to the subscriber if the subscriber answers the call. In yet another aspect of the invention, the ESP provides a method for anonymously connecting an accesser to a subscriber using a packet-based network.

The system disclosed in U.S. Pat. No. 6,353,660, incorporated herein by reference, operates not via the target (i.e. the called) telephone but via PSTN switches. Screening is not done by the voice of the source subscriber but rather by predetermined criteria such as source ID as accessed from a database that correlates a public (PSTN) telephone number with an IP address. The voice mail system vocalizes a message prompt that is routed to the source in the normal manner. But in order to also prompt the target telephone, the voice mail system must also call the target telephone. Even if a special tone or ringing signal is used that identifies the new call as originating from the voice mail system, the target subscriber must still answer the call in order to hear the message recorded by the source subscriber. Management is effected via external unit in the telephone system. Thus, from the perspective of the called subscriber, until he or she answers the voice mail system, there is no way of knowing the identity of the calling party. This means, that the called subscriber will be disturbed to the extent of answering the telephone merely in order to ascertain the identity of the calling party. This is inconvenient even if connection to the calling party is required; but if, in fact, no such connection is required the interruption is all the more undesirable.

U.S. Pat. No. 5,926,755, incorporated herein by reference, published Jul. 20, 1999 in the name of Telefonaktiebolaget LM Ericsson and entitled “Method and an arrangement for conducting multiple calls simultaneously” discloses a radio communication system including at least one radio base station and at least two telephones connected to a radio terminal. An adaptor connects the telephones to the radio terminal that is connected over a radio air-interface to the radio base station. For an outgoing call originating from one of the telephones, the adaptor senses when a particular telephone goes off-hook and signals this information to the radio base station via the radio terminal and a control channel of the radio air-interface. Then, a first traffic channel is set up between the radio base station and the radio terminal. The telephone that has gone off-hook is connected to the established traffic channel via an adaptor. Once a first traffic channel is established for a first call, signaling that a second call is to be set up may be transmitted across the first traffic channel without terminating the first call. The second call is then set up on a different traffic channel.

U.S. Pat. No. 5,625,676, incorporated herein by reference, published Apr. 29, 1997 in the name of Active Voice Corporation and entitled “Method and apparatus for monitoring a caller's name while using a telephone” discloses a method and apparatus for an auto attendant system to allow a called party to monitor a screening name left by a caller while the called party is on the telephone with a third party. If the called party wishes, the system can place the third party on hold and connect the caller. Alternatively, the system can redirect the caller to another line or ask the caller to hold. The system is implemented with a second communication channel from the telephone switch system to the called party so that the called party can monitor the screening name left by a caller without first putting the third party on hold or disconnecting from the third party. The system can be configured to automatically monitor each screening name as it is left without intervention by the called party.

It would be desirable to provide an improved mechanism for use with a voice mail system that is suitable for use with both PSTN and VolP telephone networks and wherein all of the management is effected at the handset itself, thus simplifying the arrangement, avoiding such unnecessary interruption and requiring no modification to an existing Voice Mail System.

### SUMMARY OF THE INVENTION

It is a principal object of the present invention to allow a telephone service such as a call answering service to be directed to a source telephone via a target telephone.

It is a further object of the invention to provide an improved telephone handset that is amenable for allowing such call redirection according to the invention.

These objectives are realized in accordance with a first aspect of the invention by a method for providing a method for directing a telephone service to a source telephone upon making a call to a target telephone, said method comprising:

(a) allocating the target telephone an incoming channel and an outgoing channel;

(b) upon receiving an incoming call from the source telephone via the incoming channel, detecting whether the target telephone goes off-hook;

(c) based on whether the target telephone goes off-hook, simultaneously establishing an outgoing call between the target telephone and a server providing said telephone service via the outgoing channel; and

(d) connecting the incoming channel to the outgoing channel at the target telephone so as to establish a connection via the target telephone between the source telephone and said server.

According to a second aspect of the invention there is provided a telephone comprising:

an incoming channel for connecting to a source telephone,

an outgoing channel for connecting to a server adapted to provide a telephone service, and

a switch adapted to connect the incoming channel to the outgoing channel so as direct the telephone service to the source telephone.

### BRIEF DESCRIPTION OF THE DRAWINGS

In order to understand the invention and to see how it may be carried out in practice, a preferred embodiment will now be described, by way of non-limiting example only, with regard to provision of a call answering service between a source telephone and a target telephone and with reference to the accompanying drawings, in which:

FIG. 1 shows a system according to one embodiment of the invention for providing a call answering service between a source telephone and a target telephone;

FIGS. 2 and 3 are block diagrams showing data flow in the system of FIG. 1 according to alternative embodiments;

FIG. 4 is a pictorial representation of a hybrid system according to one embodiment of the invention for providing a call answering service between a VolP source telephone and a PSTN target telephone or vice versa;

FIGS. 5a and 5b are flow diagrams showing the principal operations carried out by the target telephone in the system of FIG. 1;

FIG. 6 is a block diagram for explaining a target telephone for use with the system of FIG. 1; and

FIG. 7 is a schematic ‘Call Flow’ diagram showing signaling in the system of FIG. 1 using the SIP protocol.

### DETAILED DESCRIPTION OF THE PREFERRED EMBODIMENT

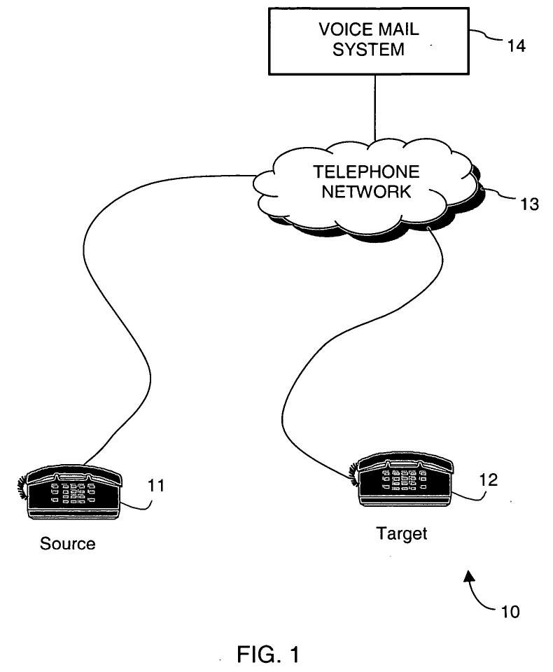

FIG. 1 shows pictorially a system 10 according to one embodiment of the invention for providing a call answering service between a source telephone 11 and a target telephone 12 interconnected via a telephone network 13 and having access to a Voice Mail System (VMS) 14.

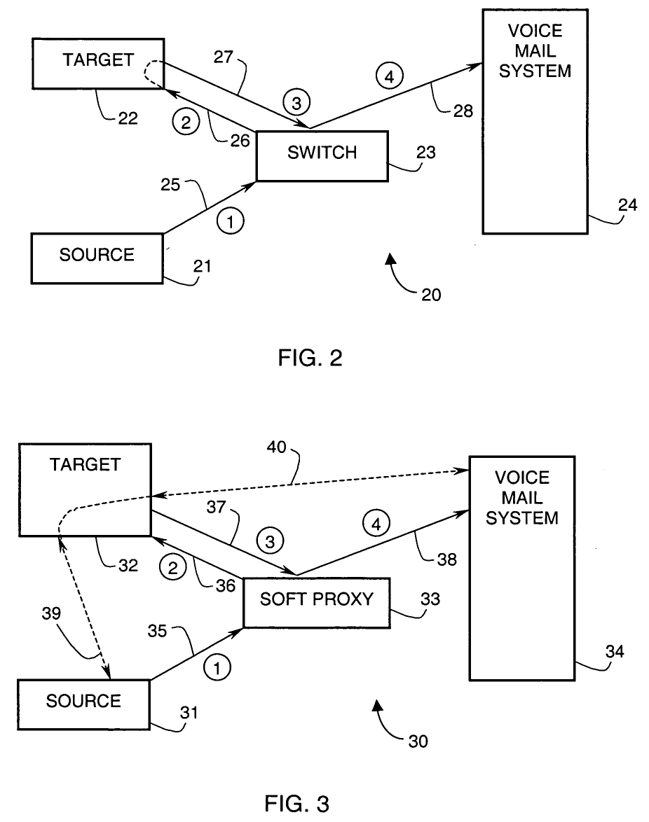

In FIGS. 2 and 3 all channels are bi-directional and the direction of the arrows between components denotes initial data flow during initiation of the call.

FIG. 2 is a block diagram showing a system 20 having a source telephone 21 and a target telephone 22 interconnected via a switch 23 that is also connected to a Voice Mail System 24. In use, the source telephone 21 initiates a call to the target telephone 22 via a channel 25. The switch 23 conveys the call to the target telephone 22 via an incoming channel 26. If the call is not answered within a prescribed time, the target telephone 22 switches the call back to the switch 23 via an outgoing channel 27, while maintaining the connection to the source telephone 21 via the incoming channel 26. The switch 23 directs the call to the Voice Mail System 24 via a channel 28, thus enabling the Voice Mail System 24 to operate in a normal manner and convey a pre-recorded message prompt via the channel 28, through the switch 23 and the outgoing channel 27 back to the target telephone 22. The message prompt is vocalized at the target telephone 22 and is conveyed via the incoming channel 26 back to the switch 23, which is still operational. By such means, the message prompt is also conveyed by the switch 23 via the channel 25 back to the source telephone 21. If the calling party opts to record a message, this message is conveyed via the same channels 25, 26, 27, 28 through the switch 23 to both the target telephone 22 as well as to the Voice Mail System 24. Consequently, if the called party is present and simply did not answer the call for any reason, he or she will now hear the recorded message and thus identify the calling party. The called party can still answer the call, in which case the connection from the target telephone 22 via the outgoing channel to 27 to the Voice Mail System 24 is terminated and the call is routed from the source telephone 21 to the target telephone 22 via the incoming channel 26.

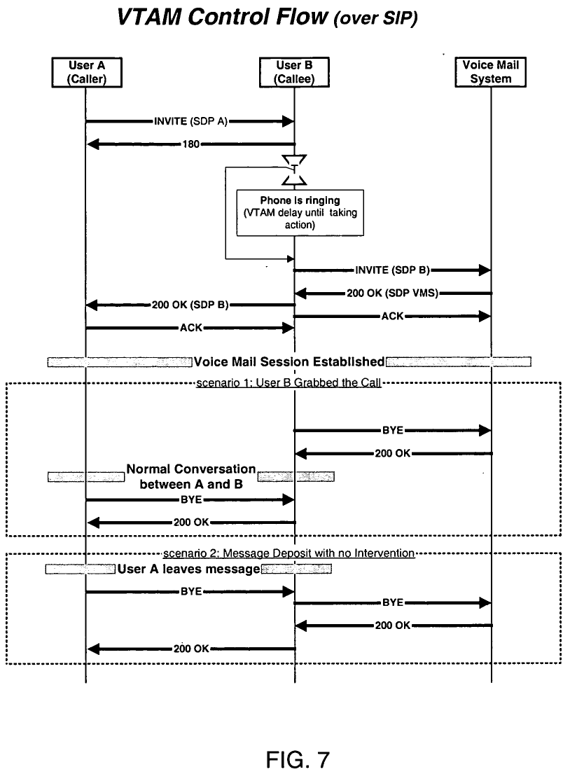

FIG. 3 is a block diagram showing a similar system depicted 30 having a source telephone 31 and a target telephone 32 interconnected via a soft proxy 33 that is also connected to a Voice Mail System 34. Operation of this system is the same as that of the system 20 as described above with reference to FIG. 2 of the drawings; and is therefore not repeated in detail. The significant difference between the system 30 shown in FIG. 3 and the system 20 shown in FIG. 2 is that the system 20 shown in FIG. 2 relates to a PSTN network, where signaling (control) and media (voice) go on the same path since both data and control signals in a PSTN network are routed together via the trunk switch. However, the system 30 shown in FIG. 3 relates to a VolP network where the switching is performed by a soft proxy 33. This gives rise to a direct media connection 39 between the source telephone 31 and the target telephone 32 and to a direct media connection 40 between the target telephone 32 and the Voice Mail System 34 that both allow for the propagation of voice traffic, while the signaling stays the same as in the PSTN network shown in FIG. 2. Thus, when the telephone call is set up, as is described in greater detail below with reference to FIG. 7 of the drawings, the source telephone 31 sends an INVITE signal to the target telephone 32 via the soft proxy 33 shown in FIG. 3. Generally, the source telephone 31 does not know the IP address of the target telephone 32 and the INVITE includes an alias or name of the target telephone similar to a URL. The INVITE signal is sent via the soft proxy 33, which determines the IP address of the target telephone 32 in much the same way that a domain server finds the IP address of a website. The INVITE signal is routed by the soft proxy 33 to the target telephone 32, which responds with a 200 OK signal when using the Session Initiation Protocol (SIP) shown in FIG. 7. The 200 OK signal includes the IP address of the target. Consequently, when the 200 OK signal reaches the source telephone 31, the latter now knows the IP address of the target telephone 32 and so is able to direct voice data packets directly to the target telephone and, of course, to receive voice data packets directly therefrom, without any need for these voice data packets to be conveyed via the soft proxy 33. It is in this sense that media is conveyed directly between two IP addresses in a VolP network as distinct from the PSTN where media is conveyed between two end-points via the trunk switch.

The systems depicted schematically in FIGS. 2 and 3 are simplified and assume that the source and target telephones are either both PSTN devices or VolP devices. In practice, no such limitation is implied and any combination of PSTN and VolP devices may be connected according to the principles of the invention. Thus, specifically, the target telephone may be a so-called POTS telephone (“Plain Old Telephone Service”) or it may be a VolP telephone. In either case, the switching between the incoming and outgoing channels is typically implemented in software, although of course, suitably activated hardware components may be used.

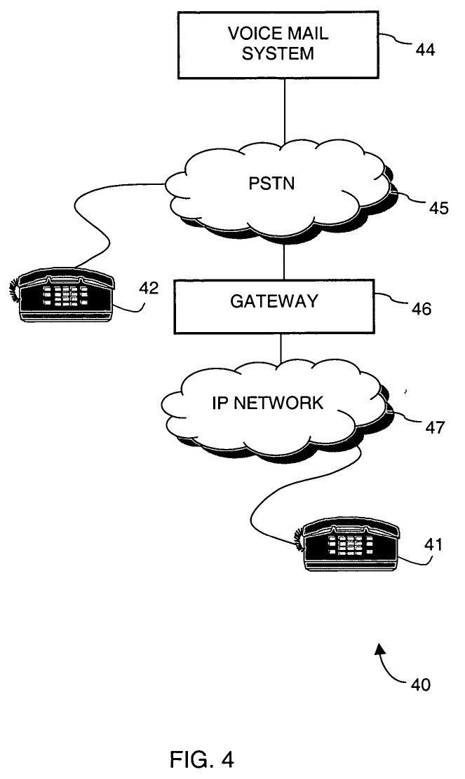

FIG. 4 is a pictorial representation of a hybrid system 40 for providing a call answering service between a VolP source telephone 41 and a PSTN target telephone 42 coupled to a Voice Mail System 44 via a PSTN network 45 that is connected via a gateway 46 to an IP network 47. The PSTN network 45 includes a switch similar to the switch 23 shown in FIG. 2; and the IP network 47 includes a proxy switch similar to the soft proxy 33 shown in FIG. 3. Each of the PSTN network 45 and the IP network 47 operates in an identical manner to the respective networks described above with reference to FIGS. 2 and 3, respectively. Thus, the only substantive difference is that signaling and media are conveyed from one network to the other via the gateway 46, which operates in a known manner to convert the signals between PSTN and IP protocols and vice versa.

By way of example, so far as the IP network 47 is concerned, the gateway 46 functions as an intermediate target that receives signaling and media from the source telephone 41. In the IP network 47, the signaling and media are received together by the gateway 46 on the same path and allow connection to the target telephone 42 via the PSTN network 45. Since the Voice Mail System 44 is already part of the PSTN network 45, the switching between the Voice Mail System 44 and the target telephone 42 is as described with reference to the PSTN system 20 shown in FIG. 2. Likewise, the connection between the incoming and outgoing channels (not shown) of the target telephone 42 remains unchanged. However, the incoming channel is coupled to the source telephone 41 via the gateway. Thus, initially Voice Mail System 44 is re-directed via the target telephone 42 to the gateway 46, which in turn determines that the required destination is the source telephone 41 in the PSTN network 47. The gateway 46 receives the signaling and media on separate paths in the PSTN network 45, performs the required protocol conversion and re-directs the signaling and media on a common path in the IP network 47 to the source telephone.

It will readily be appreciated that the source telephone 41 and the target telephone 42 can be interchanged and the Voice Mail System may be part of either the PSTN network (as shown) or can be part of the IP network 47. In all cases, operation is similar to that described above with suitable protocol conversion being performed by the gateway so as to allow propagation of the signaling and media between the two networks.

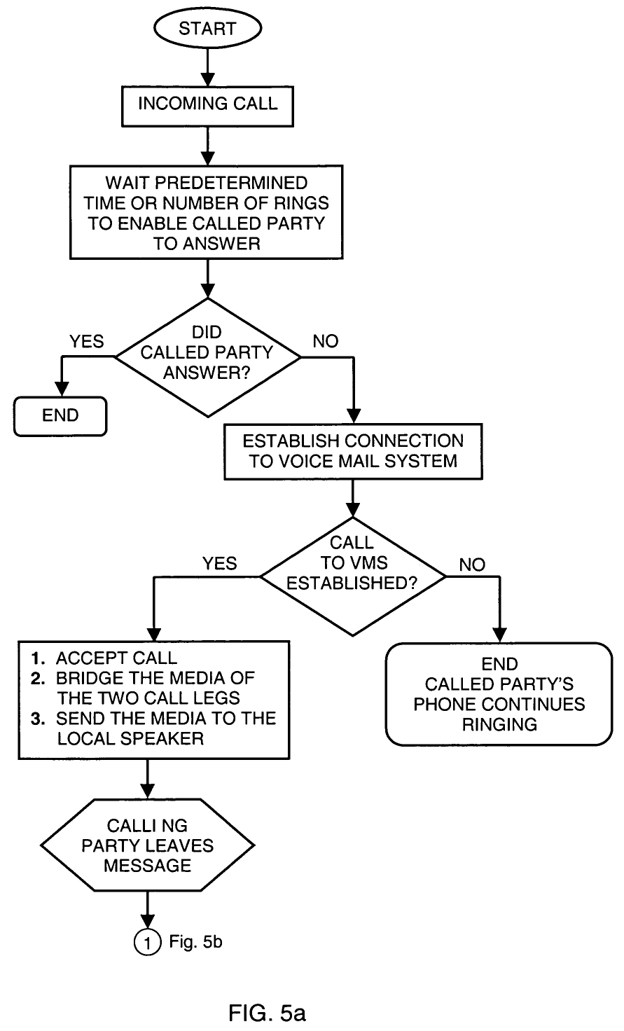

FIGS. 5a and 5b are flow diagrams showing the principal operations carried out by the target telephone 12 in the system of FIG. 1. Thus, on receipt of an incoming call, it waits a predetermined time or number of rings to enable the called party to answer. If the called party answers within the prescribed time period, no further action is taken and normal operation of the target telephone continues. In the absence of an answer within the prescribed time period, the target telephone establishes a connection to the Voice Mail System. Until establishment of the connection, the target telephone continues to ring. Upon establishment of the connection, the target telephone automatically accepts the call (i.e. goes off-hook) and bridges the incoming line to the outgoing line. This causes the target telephone to maintain the connection to the Voice Mail System via the outgoing line as well as to the source telephone via the incoming line and thus bridges between the source telephone and the Voice Mail System.

The Voice Mail System responds to the call from the target telephone by vocalizing a pre-recorded message, which is sent to the local speaker in the target telephone. Consequently, the pre-recorded message will be heard by the called party if he or she is in the vicinity of the target telephone, which may well be the case when the called party wishes to screen incoming calls before answering. Moreover, by virtue of the bridge thus effected between the source telephone and the Voice Mail System (via the target telephone) the pre-recorded message will also be heard by the calling party to whom, of course, it is primarily directed. Likewise, the calling party's response, if any, will be vocalized via the local speaker in the target telephone. If now the called party answers the target telephone, the local microphone in the target telephone is enabled in a known manner to enable the called party to answer the call, and the connection to the Voice Mail System will be disconnected. Communication then continues in the normal manner between the calling party and the called party. If the called party does not answer the call, either because he or she is absent or does not wish to speak to the calling party, communication continues between the calling party and the Voice Mail System until tear-down by either party.

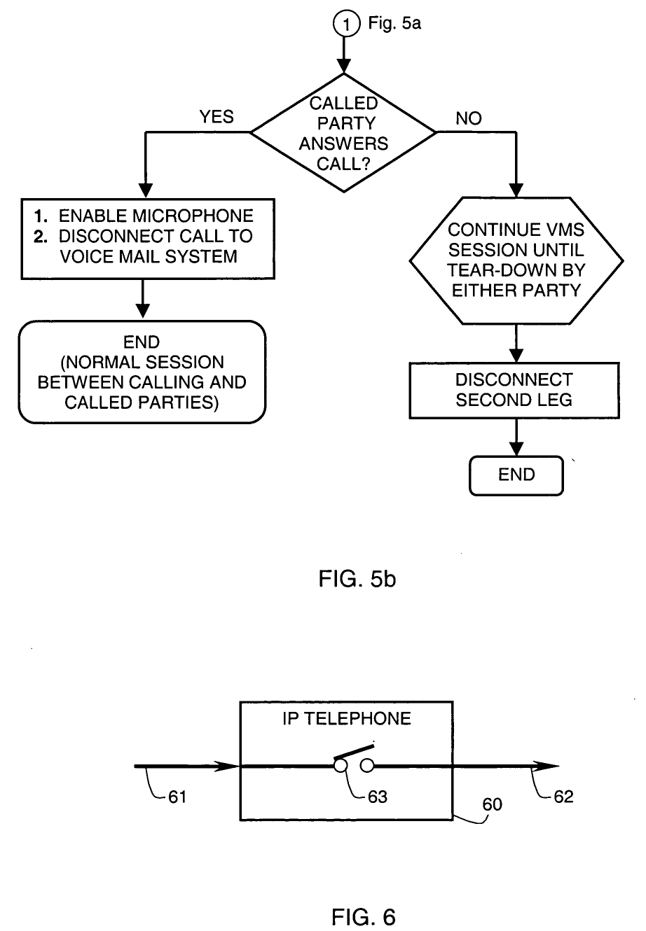

FIG. 6 is a block diagram showing functionally a target telephone 60 according to one embodiment of the invention having the ability to switch between an incoming channel 61 and an outgoing channel 62 via a switch 63.

FIG. 7 is a schematic a schematic ‘Call Flow’ diagram showing signaling in the system of FIG. 1 using the Session Initiation Protocol (SIP) (the current edge of VolP Telephony). Each arrow presents a SIP message exchanged between the parties as described in detail in the IETF RFC-3261 specification which is incorporated herein by reference. Thus, User A at the source telephone 31 calls User B at the target telephone 32. The source telephone is a VolP phone typically being a SIP application running on a PC that is used to call the target telephone 32 over the Internet. The target telephone 32 is also SIP-enabled. The source telephone 31 calls the target telephone 32 using the latter's SIP identity, a type of Uniform Resource Identifier (URI) called a SIP URI, having a form similar to an e-mail address.

SIP is based on a series of HTTP-like request/response transactions each consisting of a request that is directed to a server for invoking a particular method or function thereon and at least one response that is directed from the server to the initiating device. Thus, in FIG. 7, the source telephone (denoted as User A) sends the INVITE to the SIP server that serves the target telephone's domain. For simplicity, FIG. 7 omits the intermediate servers and shows only the principal actors in the connection: namely, the source and target telephones and the Voice Mail System, but it will be understood that the actual connections are effected via a proxy server (or more than one) as described above with reference to FIG. 3. The target telephone responds with a ringing signal denoted as 180 in the SIP protocol, which is sent back to the source telephone. When the requisite time has elapsed without the target telephone responding, the target telephone sends the INVITE signal to the Voice Mail System, which responds with the OK signal 200 and is acknowledged thereby by means of an ACK signal. Likewise, the target telephone sends the OK signal 200 to the source telephone, which is acknowledged thereby by means of an ACK signal. At this point, the Voice Mail session is established.

There are now two possible scenarios. A first scenario relates to the case where User B at the target telephone is present when the call is made but uses the system to screen incoming calls, and now grabs the call. In this case, a BYE signal is sent by the target telephone to the Voice Message System to terminate the connection to the Voice Message System. The Voice Message System responds with the OK signal 200. Thereafter, normal conversation ensues between User A at the source telephone and User B at the target telephone until the source telephone sends a BYE signal to the target telephone. The latter responds with the OK signal 200, thus denoting that the session is properly terminated.

In the second scenario, User B at the target telephone does not grab the call. In this case, User A records his message in the normal manner and then hangs up thereby sending a BYE signal to the target telephone, which in turn sends a BYE signal to the Voice Message System. The Voice Message System responds with the OK signal 200 to the target telephone and the target telephone responds with the OK signal 200 to the source telephone, thus denoting that the session is properly terminated.

It should be noted that the implementation of this invention is not limited to IP telephones, but to any telephone as long as it enables (i) access to two lines (e.g. dual line handset) and (ii) integration in the handset of a program that can control the telephone activity to perform the flow described in FIGS. 5a and 5b. For example, if an application in the telephone can establish a three-way call (a fairly common network-based feature), then the application can: (i) mute the microphone; (ii) answer the incoming call; (iii) play a message indicating the call is being forwarded to voicemail (alternatively play ring tone or, if step (iii) can be completed quickly, do nothing); (iv) establish a three-way call with the third call leg being to the Voice Mail System.

As IP Telephony has developed, a new generation of end-user telephone devices (e.g. Pingtel xpressa or Cisco 7960) has become available. These telephones allow for adding additional features by integrating additional applications. These applications can be added by the manufacturer or by third parties (for instance, using the telephone SDK). The target telephone according to one embodiment of the invention utilizes capabilities of such instruments to enable the invention to be carried out. Since IP telephony does not limit an end-user device to one voice channel at a time, the system allows for the provision of call screening with the same user experience of a Telephone Answering Machine, while using the network based Voice Mail system. More particularly, such call screening is based on a modified hand-set serving as the target telephone and requires no modification to other components in the system.

The system provides an improved manner of controlling the target telephone to achieve two media-related operations:

Bridging the voice stream between the calling party and the Voice Mail System (or other system).

Summation of both bridged streams into one stream which is sent to the target telephone's speaker.

Actually, these two operations share the same mechanism as described above and shown schematically in FIGS. 2 and 3.

### Bridging the Voice Between Two Parties

In order to bridge the voice between two parties, the target telephone needs to manipulate the incoming media streams from the two participants, and join them into one media stream. This is true both for digital PSTN networks and VolP networks, and can be easily achieved for analog networks as well with simple modification that will be clear to those skilled in the art.

A media stream from the user (i.e. the voice from that user) is defined as a discrete-time sequence of values depicting the amplitude of the voice signal. In the case that the signal is compressed and/or packetized for delivery it should be de-compressed and/or de-packetized before the manipulation.

Assuming that the media stream from user A is represented by the sequence {a₁,a₂,a₃, . . . }, and the media stream from user B is represented by the sequence {b₁,b₂,b₃, . . . }, the sum of these two streams is the summation of two corresponding elements of the streams: {a₁+b₁, a₂+b₂, a₃+b₃, . . . }.

Multiplication of a stream with a constant is the multiplication of each element in the stream with a constant such as stream A multiplied by 2 is: {2·a1, 2·a2, 2·a3, . . . }. Bridging of two media streams is the summation of the two media streams and the multiplication of the result by

$$\frac{2}{\sqrt{2}}$$

in order to maintain the same signal energy.

Thus the result of bridging two media streams A & B is the following sequence:

$$\{ \frac{2}{\sqrt{2}} ( {a}_{1} + {b}_{1} ) , \frac{2}{\sqrt{2}} ( {a}_{2} + {b}_{2} ) , \frac{2}{\sqrt{2}} ( {a}_{3} + {b}_{3} ) … \}$$

Although the system according to one embodiment of the invention has been described by way of example with regard to the provision of a call answering service between a source telephone and a target telephone, it is to be understood that the principles of the invention are applicable to the redirection of other services to the source telephone via the target telephone. Thus other services may be run via a server that may be invited by the target telephone based on an off-hook status of the target telephone for conveying an audible message or prompt to the target telephone via the outgoing channel thereof and which in turn is directed to the source telephone via the incoming channel of the target telephone. One non-limiting example of such a service is the provision of a personalized ring signal or message to the source telephone, which is maintained until the target telephone goes off-hook or until the source telephone hangs up. The personalized ring signal or message is stored on the server and directed to the target phone on receipt of an incoming call for re-directing to the source telephone via a path that is closed by the target telephone. When the target telephone goes off-hook, the server is disconnected and connection resumes via the path between the target and source telephones.

In such an embodiment, the service is provided for so long as the target telephone is not off-hook. In other words, such service is activated immediately the source telephone dials the target telephone. This, of course, is different to what happens in a voice mail system, which is activated only after a predetermined time interval if the target telephone has not yet gone off-hook.

It will also be appreciated that while the system has been described with particular regard to the provision of audio prompts and messages, no limitation is implied and the telephone service may operate to convey other types of data such as video, text and so on as well as any combination thereof.

1. A method for directing a telephone service to a source telephone upon making a call to a target telephone, said method comprising:
(a) allocating the target telephone an incoming channel and an outgoing channel;
(b) upon receiving an incoming call from the source telephone via the incoming channel, detecting whether the target telephone goes off-hook;
(c) based on whether the target telephone goes off-hook, simultaneously establishing an outgoing call between the target telephone and a server providing said telephone service via the outgoing channel; and
(d) connecting the incoming channel to the outgoing channel at the target telephone so as to establish a connection via the target telephone between the source telephone and said server.

2. The method according to claim 1, wherein the server is directed to the target telephone via the outgoing channel if the target telephone does not go off-hook within a predetermined time interval.

3. The method according to claim 2, wherein the server is part of a Voice Mail System.

4. The method according to claim 1, wherein the server is directed to the target telephone via the outgoing channel until the target telephone goes off-hook.

5. The method according to claim 4, wherein the server conveys a personalized ring signal or message to the target telephone.

6. The method according to claim 1, wherein the connection via the target telephone between the source telephone and the server is effected via a PSTN switch.

7. The method according to claim 1, wherein the connection via the target telephone between the source telephone and the server is effected via a soft proxy.

8. The method according to claim 1, further including:
directing media and signaling between the source telephone and the target telephone via a gateway for effecting protocol conversion between PSTN and IP telephony protocols.

9. A telephone including:
an incoming channel for connecting to a source telephone,
an outgoing channel for connecting to a server adapted to provide a telephone service, and
a switch adapted to connect the incoming channel to the outgoing channel so as to direct the telephone service to the source telephone.

10. The telephone according to claim 9, wherein:
the switch is responsive to an incoming call received from a source telephone via the incoming channel for simultaneously establishing an outgoing call between the target telephone and the server via the outgoing channel conditional on an off-hook status of the target telephone;
thereby establishing a connection between the source telephone and the voice mail system so as render a message prompt produced by the server at the target telephone and conveying said message prompt to the source telephone.

11. A telephone system including:
a target telephone having an incoming channel and an outgoing channel;
a source telephone coupled to the target telephone via the incoming channel;,
a server coupled to the target telephone via the outgoing channel for providing a telephone service; and
a switch in the target telephone adapted to connect the incoming channel to the outgoing channel so as to redirect a call received from the source telephone on the incoming channel to the server while maintaining connection to the source telephone.

12. The telephone system according to claim 11, wherein the server conveys the service to the target telephone via the outgoing channel if the target telephone does not go off-hook within a predetermined time interval.

13. The telephone system according to claim 11, wherein the server is part of a Voice Mail System.

14. The telephone system according to claim 11, wherein the server is directed to the target telephone via the outgoing channel until the target telephone goes off-hook.

15. The telephone system according to claim 14, wherein the server conveys a personalized ring signal or message to the target telephone.

16. The telephone system according to claim 11, including a PSTN switch for effecting the connection via the target telephone between the source telephone and the server.

17. The telephone system according to claim 11, including a soft proxy for effecting the connection via the target telephone between the source telephone and the server.

18. The telephone system according to claim 11, further including:
a gateway coupled between the source telephone and the target telephone for effecting protocol conversion between PSTN and IP telephony protocols.

19. A method for directing a telephone service to a source telephone when making a call to a target telephone, said method comprising:
(a) establishing an outgoing call between the target telephone and a server providing said telephone service via an outgoing channel; and
(b) connecting an incoming channel to the outgoing channel at the target telephone so as to establish a connection via the target telephone between the source telephone and said server.

20. The method according to claim 19, wherein the server is connected to the target telephone via the outgoing channel if the target telephone does not go off-hook within a predetermined time interval.

21. The method according to claim 20, wherein the server is part of a Voice Mail System.

22. The method according to claim 19, wherein the server is connected to the target telephone via the outgoing channel until the target telephone goes off-hook.

23. The method according to claim 22, wherein the server conveys a personalized ring signal or message to the target telephone.

24. The method according to claim 19, wherein the connection via the target telephone between the source telephone and the server is effected via a PSTN switch.

25. The method according to claim 19, wherein the connection via the target telephone between the source telephone and the server is effected via a soft proxy.

26. The method according to claim 19, further comprising:
connecting media and signaling between the source telephone and the target telephone via a gateway for effecting protocol conversion between PSTN and IP telephony protocols.
